(19) United States
(12) Patent Application Publication
(10) Pub. No.: US 2005/0032027 A1
(43) Pub. Date: Feb. 10, 2005

(54) System and method for creating coded text for use in teaching pronunciation and reading, and teaching method using the coded text

(76) Inventors: Irene M. Patton, Poway, CA (US); Hubert Halkin, La Jolla, CA (US)

Correspondence Address: GORDON & REES LLP, 101 WEST BROADWAY, SUITE 1600, SAN DIEGO, CA, 92101, US

(21) Appl. No.: 10/637,104

(22) Filed: Aug. 8, 2003

(51) Int. Cl. G09B 17/00

(52) U.S. Cl. 434/170; 434/156

(57) ABSTRACT

A system and method for teaching pronunciation and reading uses a color coded text as a teaching tool. The color coded text passage has a first unique color coding applied to all vowel letters and letters having vowel-like pronunciation, and a second unique color coding applied to all consonants having nonstandard pronunciations. The colors used for vowels are selected based on the presence of the same vowel sound in the word used for the particular color. A computer system is programmed for use by a user having an understanding of proper pronunciation to convert standard black and white text into color coded text. A dictionary of previously coded words is searched to identify any words which are present in the text, and such words are converted to their color coded form. The user converts all uncoded words by selecting letters in each word in turn and applying the appropriate color coding using a color coding menu which is displayed on the screen.

### BACKGROUND OF THE INVENTION

The present invention relates to a teaching tool and method for teaching pronunciation and reading utilizing color to identify different voiced sounds in a language, and is particularly concerned with a system and method for creating color coded text as a tool for use in such a teaching system.

Educational devices which use color in teaching of pronunciation have been proposed in the past, but these have been mechanical and generally complex in nature. U.S. Pat. No. 4,643,680 of Hill describes a teaching device and method for teaching reading or pronunciation using colors to represent different vowel sounds. The teaching device has letters or letter combinations on the periphery of three or five rotatable discs, and these are individually manipulated to form words in a window. One of the rotatable discs bears different vowel symbols which are either colored or displayed on a colored background. The pronunciation of the vowel and the pronunciation of the vowel in the name of the associated color have a phonetic relationship. Thus, the color green is used to represent the vowel sound “EE”, the color black is used to represent vowel sound “AH”, and so on. Ghost letters (letters printed in outline) are used to represent silent letters in a word, such as the “g” in “gnat”. Other letters are simply shown in standard text, with no color coding. Thus, this tool only teaches pronunciation of vowels and silent letters, not different consonant pronunciations. Also, only a single word can be displayed at any one time, making the device slow and difficult to use. It does not permit display of a lengthy passage of coded text altogether at one time.

U.S. Pat. No. 4,443,199 of Sakai describes another teaching method using different sets of tiles. One set of tiles has a vowel symbol on one side and a distinctively colored blank surface on the other side to represent a different phonetic vowel sound. Another set of tiles has phonetic consonant symbols. The tiles in this set are of different shapes to represent different consonants, and are also differently shaped from the vowel tiles. The shaped consonant tiles may also incorporate different colors. Another set of tiles simply shows each letter of the alphabet in a conventional way. The teacher can combine individual tiles from the three sets to represent a word. However, this system is also relatively complex to use, requiring assembly of one word at a time, and has no assistance as to consonant pronunciation. U.S. Pat. No. 5,567,159 of Tehan also uses different visual indicator members to represent vowel letters and consonant letters, using different colors, heights, and the like to distinguish different letters. This is also not particularly easy to use and provides no hints as to proper pronunciation based on the sound of the color word.

### SUMMARY OF THE INVENTION

It is an object of the present invention to provide an new and improved system and method for teaching reading and pronunciation, and a new and improved system and method for creating coded text for use in such a system and method.

According to one aspect of the present invention, a teaching method for teaching pronunciation and reading is provided, which comprises utilizing a color coded text passage in which all letters having vowels and vowel-like sounds are represented in colors whose color name contains the same phoneme as the vowel or vowel-like sound that it represents, letters corresponding to vowel diphthongs having two vowel sounds are represented by both background color and letter character color, each color having a color name containing the same phoneme as the vowel sound it represents, all consonant letters having non-standard pronunciations are represented in predetermined colors, and all consonant letters having standard pronunciation are not color coded; and teaching the pronunciation of words in the text using the color coding to indicate proper pronunciation.

The colors selected for consonants are based on whether the sound of pronouncing the consonant is a vowel-like sound. If it is vowel-like, the same color as is used for that vowel sound may be used. If not, colors or color shades different from those selected for the vowels are used.

According to another aspect of the present invention, a method for converting a standard passage of text into the corresponding text which is color coded to represent proper pronunciation of each word in the text is provided, which comprises providing a dictionary of some common words converted into corresponding color coded words in the data base of a computer, entering a conventional text passage into a computer, displaying the passage on the computer screen, converting all words found in the passage which are in the dictionary into the corresponding color coded word and displaying the converted words in the passage on the screen along with the non-converted words not found in the dictionary, allowing the user to code all non-converted color words in the passage into color coded words, and displaying the passage on the screen with all words converted into the corresponding color coded words.

In an exemplary embodiment of the invention, each time a user converts a new word into a color coded word, that word is added to the dictionary in the data base for future use. The user can print out the color coded passage, send it to other users, or use it in any other desired fashion, such as on a computer, to teach reading and/or pronunciation. A set of rules are provided for selecting the color or colors to be associated with each letter in an uncoded word, and these rules are provided or displayed to the user for use in coding words. All vowels and vowel-like sounds are represented in colors whose color name contains the same phoneme as the vowel or vowel-like sound that it represents (e.g. the “eh” sound of the “e” in red). Diphthongs, such as the “eeoo” sound in the word “view”, are represented by both background color and foreground (letter character) color. Thus, the “iew” of the words “view” or “review” is represented by coloring each letter in blue and the background of all three letters in green. Silent letters (such as the “g” in gnome) are represented in a unique, non-prominent color which is not used for any other coding, such as gray, for example. Consonant letters which have only one possible pronunciation are displayed in the standard color assigned to the text, such as black. If the consonant has more than one pronunciation option, depending on the word in which it occurs, the most common pronunciation will be represented in the standard text color (black), while the alternate pronunciation is represented in a different color. Thus, the letter “c” will be colored black where it is pronounced in the most common way as in the word “cat”, and will be colored a different way, such as blue, when pronounced “see” as in the word “process”.

In the exemplary embodiment of the teaching method and the method of making a color coded text for use in the teaching method, letters in words which correspond to vowel sounds are white with a background color corresponding to the vowel sound, diphthong groups of letters have a colored letter and different colored background, silent letters are colored gray, standard or most common pronunciation consonant letters are colored black, and alternate pronunciation consonant letters are colored based on the consonant sound. Once a teacher has learned the color coding pronunciation rules, they can readily convert any standard text into appropriately color coded text, without undue effort. When the student has also learned the pronunciation rules, they will be able to read and pronounce a color coded text passage relatively accurately. This will reinforce basic pronunciation, allow new vocabulary to be introduced, and clarify difficult pronunciations.

According to another aspect of the present invention, a system for producing color coded text for use in teaching proper pronunciation is provided, which comprises a computer, display means associated with the computer, the computer having input means for receiving selected text passages and displaying the uncoded passage on the screen to a user, storage means in the computer containing a dictionary of commonly used words in which each word is color coded to represent the proper pronunciation of that word, a program associated with the computer for searching uncoded text and associating any words in the text which are stored in the dictionary with the corresponding color coded word and displaying the color coded words in the text on the display means, the program further comprising rules for color coding of letters in words which are not already stored in the dictionary, means for displaying the rules to a user, means for color coding letters in displayed text according to instructions entered by the user based on the rules, and means for displaying the text passage with all words color coded after all words have been either associated with words already stored in the dictionary in color coded form or have been color coded by the user according to the stored rules.

The system and method of an exemplary embodiment of the invention is specifically designed for American English pronunciation, but an equivalent system may be designed to teach pronunciation in any language as well as British English, simply by selecting appropriate colors to represent letters or letter groups in words, based on the pronunciation of those colors in the language in question. This system and method enables color coded text passages to be created quickly and easily on a computer for use in teaching pronunciation and reading. The teaching method using the color coded text will considerably simplify the process of acquiring good pronunciation skills.

### BRIEF DESCRIPTION OF THE DRAWINGS

The patent or application file contains drawings executed in color. Copies of this patent or patent application publication with color drawings will be provided by the Patent Office upon request and payment of the necessary fee.

The present invention will be better understood from the following detailed description of an exemplary embodiment of the invention, taken in conjunction with the accompanying drawings in which like reference numerals refer to like parts and in which:

FIG. 1 is a block diagram of an exemplary computer system for implementing an exemplary embodiment of the invention;

FIG. 2 is a simplified flow chart illustrating a method of color coding a text passage based on proper pronunciation of each word, according to an exemplary embodiment of the invention;

FIGS. 3A and 3B are more detailed flow charts illustrating the color coding sequence;

FIG. 4 is a flow diagram illustrating steps for altering selected display features after file creation;

FIG. 5 is a color rendering of a screen display which allows parameters selected in red, green, blue values that are used to determine the coding of letters in words according to their pronunciation;

FIG. 6 is a table indicating the code numbers assigned in the system to non-standard consonant or consonant-like pronunciations; and

FIGS. 7 to 14 are color drawings of screen displays that are generated at various points in the exemplary embodiment.

### DETAILED DESCRIPTION OF THE DRAWINGS

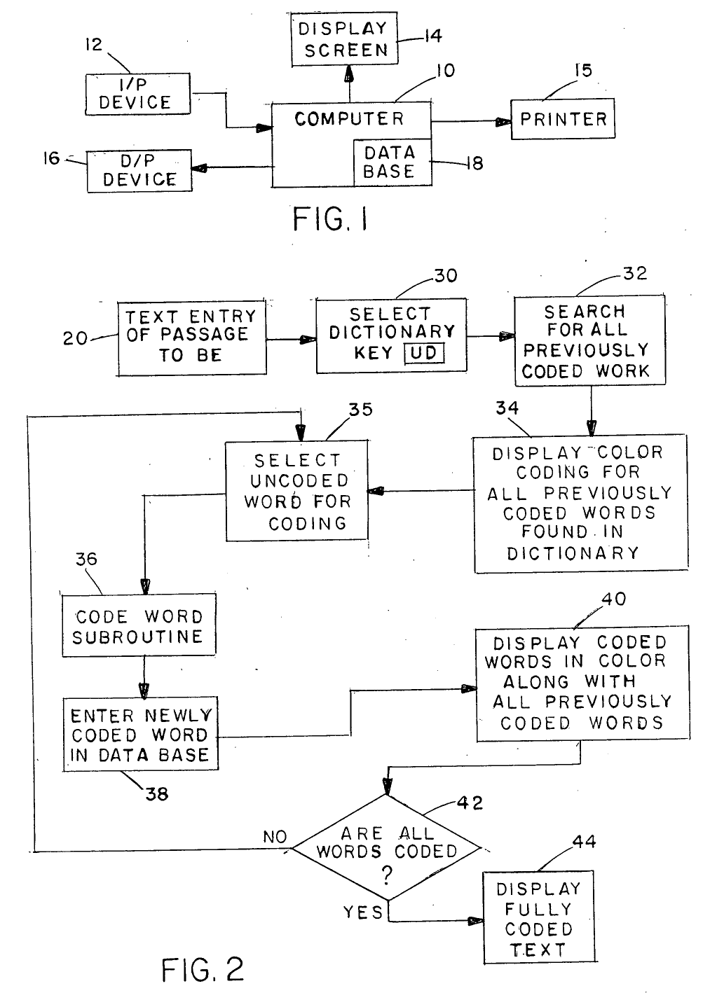

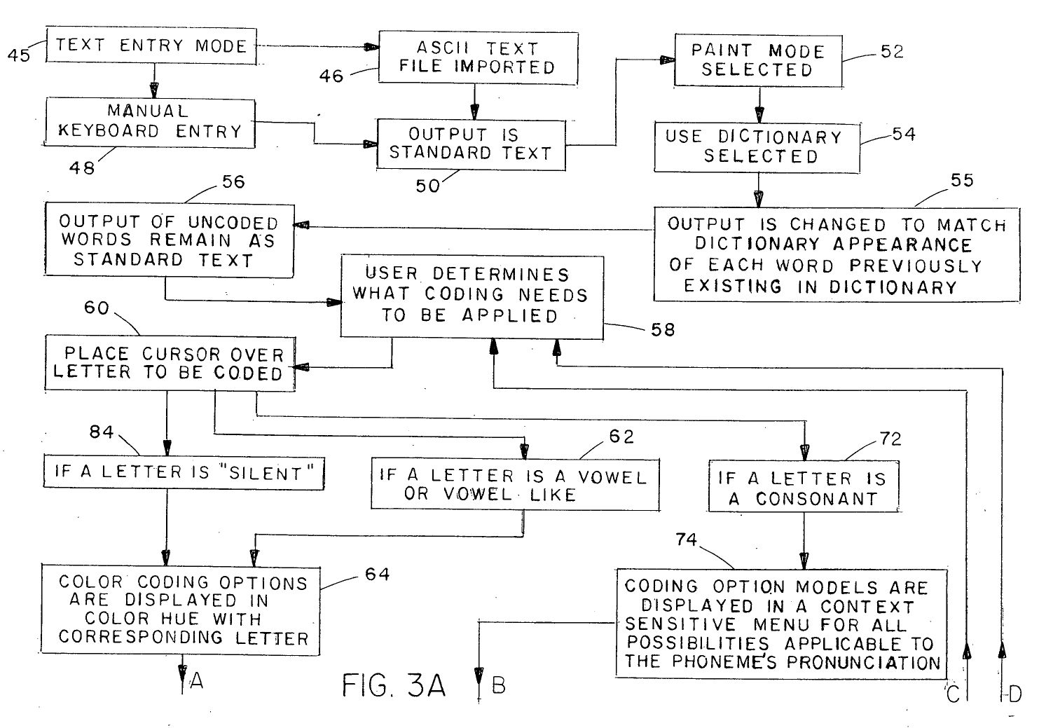

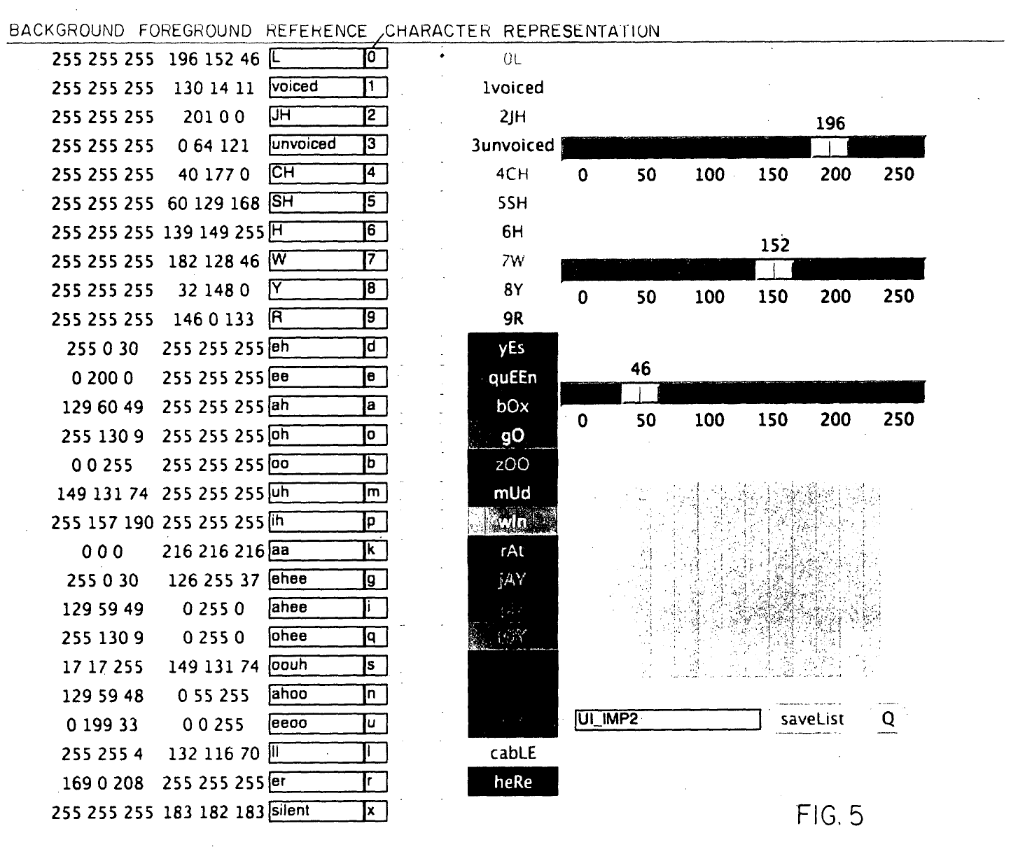

A computer system for use in a system and method for creating a teaching tool in an exemplary embodiment of this invention is illustrated in FIG. 1, while FIGS. 2 to 4 are flow diagrams of the software used in this system to create the teaching tool for teaching reading and pronunciation according to the exemplary embodiment of the invention. FIGS. 5 to 14 are screen displays generated at various points by the software, as will be explained in more detail below. The system and method in the exemplary embodiment are designed to create a teaching tool for teaching pronunciation and reading in the American English language, but it will be understood that the same principles may be used in alternative embodiments for creating color coded texts for use in teaching other languages and alternative English pronunciation, such as British English.

The computer system basically comprises a computer 10 with an input device 12 such as a keyboard and a mouse, or other standard computer input device, a conventional display screen 14 linked to the computer 10, a color printer 15 for printing output from the computer, and any other conventional output device 16 such as a modem or network connection for linking the output to other computer stations. The computer system includes a memory or data base 18, which may be a hard disk, floppy disk, optical disk, or other data storage means. Stored in the data base is a dictionary of commonly used words in English, each word being associated with a color coded word, the word being color coded according to the rules explained below. Other words which are not already stored in the dictionary will be color coded as they occur in a selected text passage by the user, according to the software illustrated in the flow diagrams of FIGS. 2 to 4.

The color-coding rules for the pronunciation teaching system and method of the exemplary embodiment will first be explained, followed by the computer software for creating English text with the proper coding according to those rules, as a teaching tool. In the reading method, colors are used to represent all of the basic vowel and non-standard consonant sounds in American English, as well as unvoiced or silent letters in words. The colors used to represent the vowel sounds are selected based on the fact that the vowel sound used when sounding the color word is the same as the vowel sound it represents. In other words, all vowel and vowel-like sounds are represented in colors whose color name contains the same phoneme as the vowel and vowel-like sound that it represents, as shown in Table 1 below.

TABLE 1
Single Phoneme Vowel Sounds

| Vowel Sound | Color | Example words with same vowel sound |
|---|---|---|
| EH | RED | YES, BLESS |
| EE | GREEN | QUEEN, SCREEN |
| AH | AUBURN | BOX, PROCESS |
| OH | ORANGE | GO, ASSOCIATE |
| OO | BLUE | TO, ZOO |
| UH | MUD | THE (when followed by word starting |
| | | with a consonant), COLOR |
| IH | PINK | WIN, IN, USING |
| AA | BLACK | RAT, HAT |

These eight basic colors are used for the eight basic single phoneme vowel sounds listed above. In the exemplary embodiment of the invention, the appropriate background color as listed above is displayed behind one or more white letter characters, to represent the single phoneme pronunciation.

There are also diphthong or two phoneme vowel sounds. In these cases, the initial or first phoneme is displayed as background color and is the same color as the corresponding single phoneme from Table 1 above. The final phoneme is displayed in the color of the letter character, and is again the same color as the corresponding single phoneme. The double phonemes or diphthongs are listed below in Table 2, along with the associated color coding.

TABLE 2
Diphthong Vowel Sounds

| Diphthong | Color Coding | Example |
|---|---|---|
| EHEE | Red background, green letter | JAY |
| AHEE | Auburn background, green letter | PIE, LIKE |
| OHEE | Orange background, green letter | TOY |
| OOUH | Blue background, mud color letter | FOOT |
| AHOO | Auburn background, blue letter | NOW |
| EEOO | Green background, blue letter | VIEW |

Instead of using two of the single sound vowel colors for the diphthong vowel sounds, as indicated above, six additional colors may be used to identify these sounds. For example, the color GRAY may be used for EHEE, the color WHITE may be used for AHEE, the color TURQUOISE may be used for OHEE, the color SOOT may be used for OOUH, the color BROWN may be used for AHOO, and the color PUCE may be used for EEOO.

Two other voiced, vowel-like sounds are represented by different background colors where the sound produced by pronouncing the color word corresponds to the vowel-like sound. The pronunciation LL or “EL” (for example in the word CABLE) is represented by a YELLOW background color, and the sound ER is represented by a PURPLE background (e.g. in the words HERE, COLOR).

Any silent letters in the text may be represented in a unique, non-prominent hue, such as a very light gray letter on a white background. Standard consonants, i.e. those letters which have only one pronunciation, such as M, are represented in the unaltered standard text format, i.e. black on a white background. Some consonants have two or more pronunciation options. One of these is the letter “G” as pronounced in the words “GO”, “AGE”, and “ROUGE”, for example. In this case, the most common pronunciation, such as the G of GO, is represented in the standard (black) text. For the first level variation from the standard pronunciation, as occurs in words such as “AGE”, the letter “G” is colored dark red, representing a voiced consonant variation from the standard. In the case of the second level variation from the standard pronunciation, occurring in words such as “ROUGE”, the letter “G” is colored a brighter red. Both shades of red indicate a letter which is articulated with sound from the vocal folds, i.e. a voiced consonant.

For consonants which are unvoiced or non-voiced, i.e. articulated without using the vocal folds, different shades of blue are used to represent the pronunciation. Dark blue is used to represent the first level, non-voiced variation from the standard, such as the letter “c” as used in the word “NICE”, and the letter “d” as used in the word “LIKED”. A brighter blue is used for the second level non-voiced variation in pronunciation, such as the letter “c” in the word “SPECIAL”, the letter “s” as in “SUGAR”, and the letter “t” as in “NATION”. Bright green is used for other non-voiced variations, such as the sound of “ch” as in “CHURCH” and “t” as in “NATURE”.

There are other voiced and non-voiced consonant pronunciation variations, which are provided using the same colors as in the vowel tables above. This is used where the initial articulation is the same as the vowel sound represented by that color. Table 3 below lists all the colors used for non-standard consonant letters and consonant-like pronunciations in order to indicate the pronunciation. Silent letters are indicated by the color gray, as noted above, and are those which appear in a word but are not articulated in any way whatsoever, such as the “g” in “GNAT”, the “b” in “LAMB”, and the “e” in the word “ATE”.

TABLE 3
Consonant Color Coding Table

| Control | Color of | | Examples of words with |
|---|---|---|---|
| number | letter | Letters | associated pronunciation |
| 1 | Dark red | d, f, g, n, s, t | SOLDIER, OF, AGE, SING, IS, |
| | | h, x | THE, XEROX |
| 2 | Brighter red | g, n, s, z | ROUGE, BLANC, ASIA, |
| | | | AZURE |
| 3 | Dark blue | c, ch, d, gh, | NICE, ACHE, LIKED, |
| | | ph, th | ENOUGH, PHONE, THREE |
| 4 | Bright green | ch, t, tch | CHURCH, NATURE, CATCH |
| 5 | Brighter blue | c, ch, s, | SPECIAL, MACHINE, |
| | | sh, t | SUGAR, SHE, NATION |
| 6 | Pale blue | h | UPHILL |
| | (indicates | | |
| | aspiration) | | |
| 7 | Mud (uh or | o, u, w | CHOIR, QUIET, WET |
| | schwa | | |
| | sound) | | |
| 8 | Green* | e, i, y | NAUSEOUS, ONION, YAP |
| | (articulation | | |
| | begins with | | |
| | “ee”) | | |
| 9 | Purple | r | RUN |
| | (articulation | | |
| | begins as in | | |
| | “er” of | | |
| | purple) | | |
| 0 | Mud (uh) | l, o* | LOW, ONE |

*= vowel or vowel-like letter having a consonant pronunciation option, where the initial pronunciation is the same as the vowel sound, but the function (and thus the duration of articulation) is as a consonant.

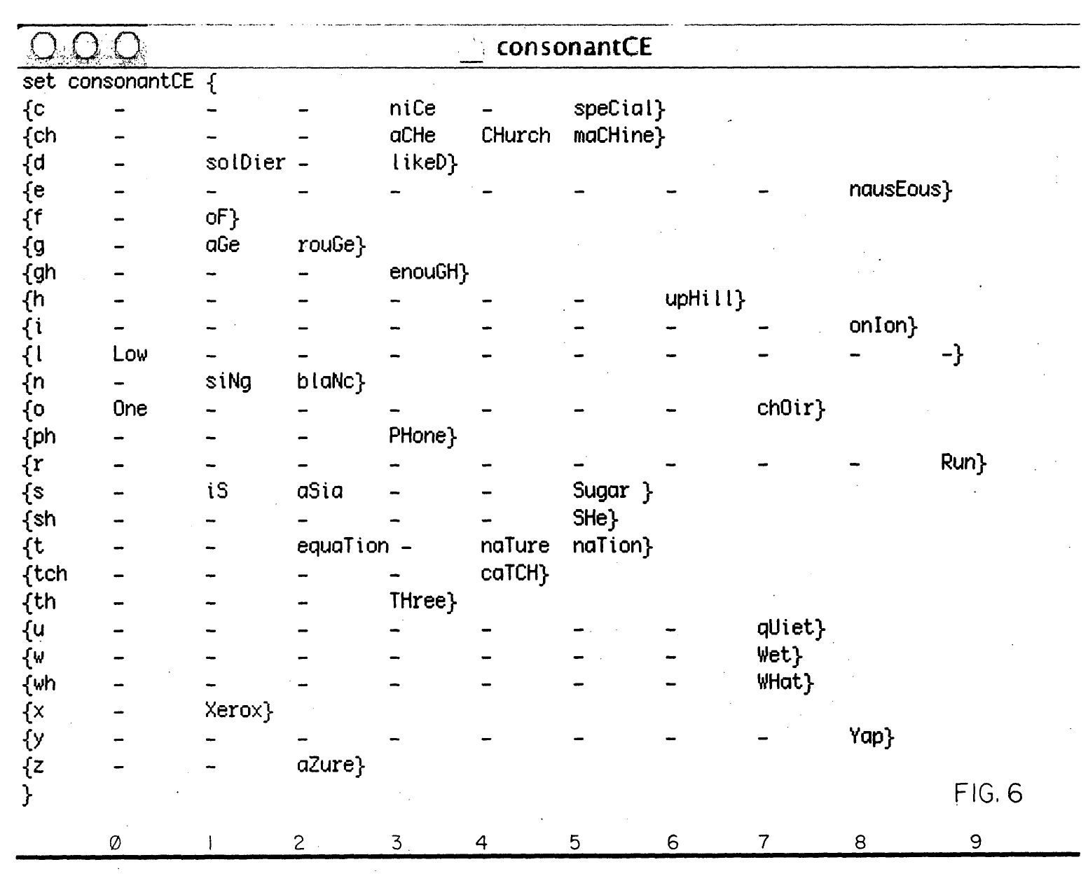

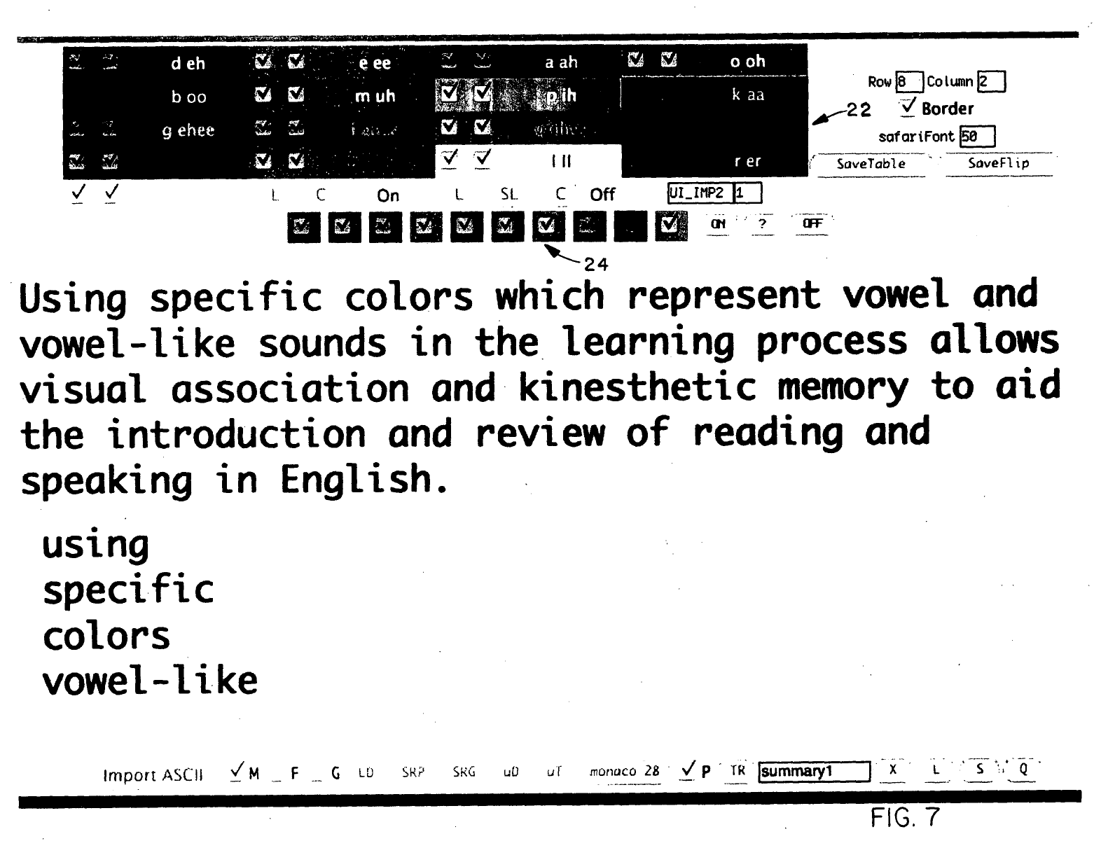

The foregoing tables 1 to 3, along with the use of the color for silent letters and the color black for standard consonant pronunciations, can be used to code any sample of English text with the corresponding letter colors and background colors. Once the reader has learned the pronunciation rules for the colors and color combinations, they will be able to pronounce the words correctly. In the software for creating color-coded text from black and white text, control characters (numbers and letters) are used to indicate the different colors to be applied to the letter foreground and/or background. FIG. 5 is a chart illustrating the various control characters along with the associated color coding according to tables 1 to 3, and this information will be stored in the computer database. FIG. 6 is a table of exemplary words associated with each of the consonant control numbers 0 to 9 in the computer data base, and is used as described in more detail below in connection with the flow charts of FIGS. 2 to 4 and the display screens of FIGS. 7 to 14.

Chrometics editor software, as illustrated in FIGS. 2 to 4, is provided to enable the user to convert any English text passage into color coded text according to the scheme described above. The software is written in the tcl/tk computer language. This is a powerful programming environment which produces programs which can be run on Windows, Mac, Linux, and Unix machines. Tcl/tk is object-oriented, event-driven and comes with a large collection of predefined “widgets”, i.e. buttons, canvases, texts, and so on. It is possible to create new “widgets” as needed. While the chromatics editor software is running, a chrometics text is represented by a tcl/tk “text widget” in which each part of a text can receive one or more tags. A tag may contain various specifications as to how the characters should be represented, such as font, font size, foreground and background colors, and so on. Tags may be attached to any portion of a text, from a single character to the entire text. The hard drive file representation of a chrometics text will contain all the characters, all the relevant tags, all the tag definitions, and specific information about which tag is applied to which part of the text.

The software has an input function to read in a chrometics text file and display it on the computer screen, and an output function to save a chrometics text into a chrometics text file. The chrometics editor has two main modes: a text entry mode and a paint mode. The text entry mode is similar to a standard editor: whatever is keyed in or input in any other way will appear as standard black-on-white text on the computer screen (see FIG. 7). The painting mode, as will be described in more detail below, enables the user to apply background and/or foreground color to any character in the text. The painting is accomplished either by picking a color from a palette and clicking it to the character, or by pressing a specific control key while the mouse cursor is located on the character. In software terms, this is implemented by associating to mouse and/or keyboard events some specific “bindings” which apply the relevant color tags to the characters of the tcl/tk text widget. Once a word has been “painted”, it is automatically entered into the database 18.

The overall functions of the chrometics editor software will now be described with reference to FIG. 2. The first step 20 is the entry of the text passage to be coded. This may be done by typing in at the keyboard, or by importing a file, such as an ASCII text file. FIG. 7 illustrates the screen display at the stage of creating a black and white text file for editing. The imported or keyed-in text is displayed in black and white in the central region of the screen. A color-coding menu is displayed on the top of the screen for review by the user when selecting the appropriate color coding for a letter or group of letters in a word. The menu comprises a color palette or chart 22 of the basic vowel sounds and diphthong vowel sounds, and a row 24 of boxes of the various non-standard consonant pronunciation colors. Palette 24, containing the associated colors of Table 1, as well as the diphthong vowel sounds of Table 2, the EL (yellow) and ER (purple) pronunciations, and the gray for silent letters, is provided across the top of the screen. The various non-standard consonant pronunciation colors of Table 3 are provided in the row 24 along the bottom of the palette 22.

Various control buttons are provided across the bottom of the screen. The button labeled “Import ASCII” loads standard text file from wherever the system has access. Button M, if selected, shows all real time activity in a special window. If not selected, the text input area is larger. If button F is selected, the text input area of the screen only is displayed. If not selected, the color selection keys are displayed on the screen. G if selected shows editing features normally hidden, such as space, tab, etc. Button uD is used to apply coding from the dictionary, and button uT is used to write coding to the dictionary. Button TR is used to control the screen display. Button X closes the file, button S saves the file, and button Q quits or exits the program.

Some control keys are also provided in the top portion of the screen, associated with the color palette. Each color in the palette 22 has two boxes to its left, which may be checked or unchecked depending on the display desired. In FIG. 7, all of these boxes are checked. The first box is for letter, or L, and the second box is for color, or C. These can be turned on or off by depressing the L or C on button or off button below the palette. The color boxes in row 24 also have a central box which may be checked or unchecked. All of these boxes are also checked in FIG. 7. The ON and OFF buttons to the right of the row 24 may be depressed in order to check or uncheck one or more of these boxes.

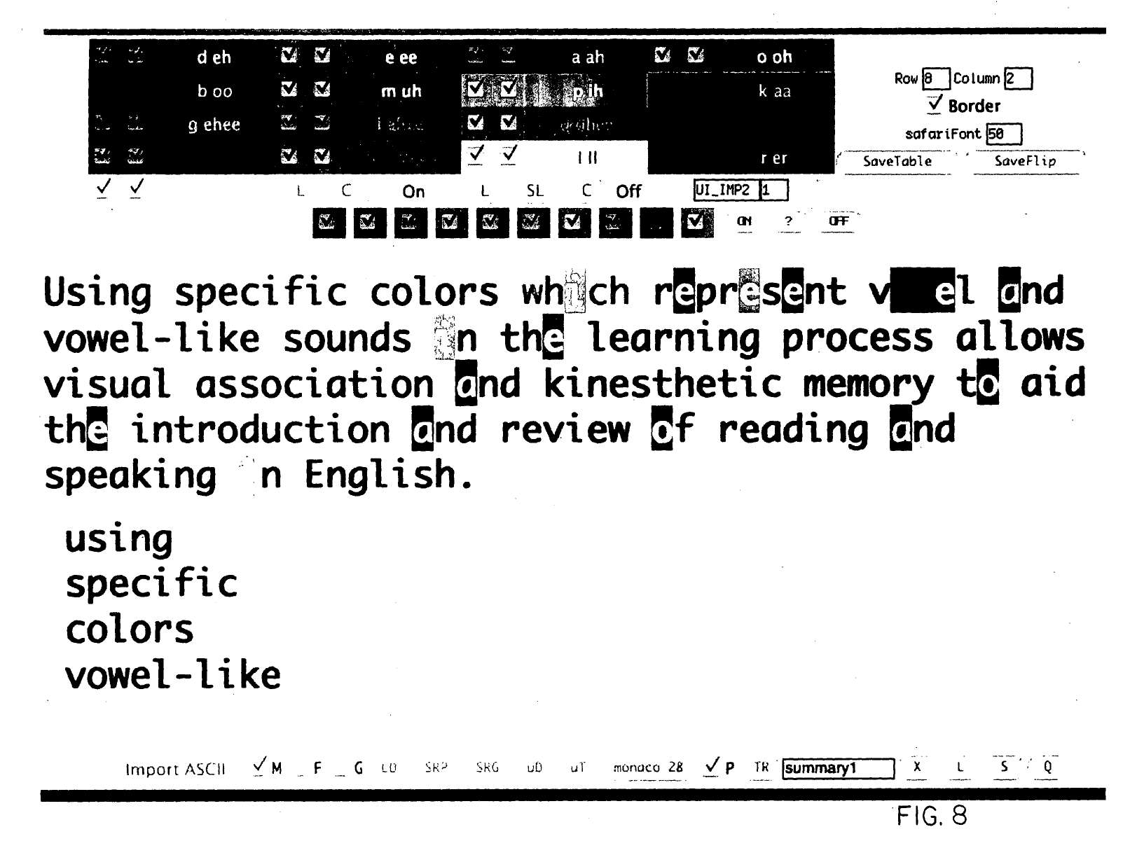

Returning to the basic flow diagram of FIG. 2, once the desired black and white text has been imported, the user selects key P (for painting mode) and depresses key uD at the bottom of the screen (step 30). The text is then searched and compared with the stored dictionary of coded text (step 32). The color coding for all previously coded words found in the text is then displayed (step 34). An exemplary screen display showing the text with all previously coded words having the appropriate color coding is illustrated in FIG. 8. Thus, the coded word “and” appears with the letter “a” having a black background (representing the “aa” vowel pronunciation), and the letters “n” and “d” as unchanged black text, since each has its standard or most common pronunciation. The word “which” is more complex. The letter “w” is mud-colored (consonant code character 7) and the letter “h” is light blue (consonant code character 6). The letter “i” is white with a pink background (indicating vowel pronunciation “ih”, like the “i” in the word pink). Finally, the letters “c” and “h” of “ch” are each colored bright green (consonant code character 4). Other coded words in FIG. 8 follow the same rules. In the word “vowel”, the letter “v” remains black (standard pronunciation) and the letters “ow” are colored blue with an auburn background (representing the diphthong vowel sound “ahoo”). The letter “e” is white with a mud-colored background (vowel sound “uh”), and the letter “I” has a yellow background.

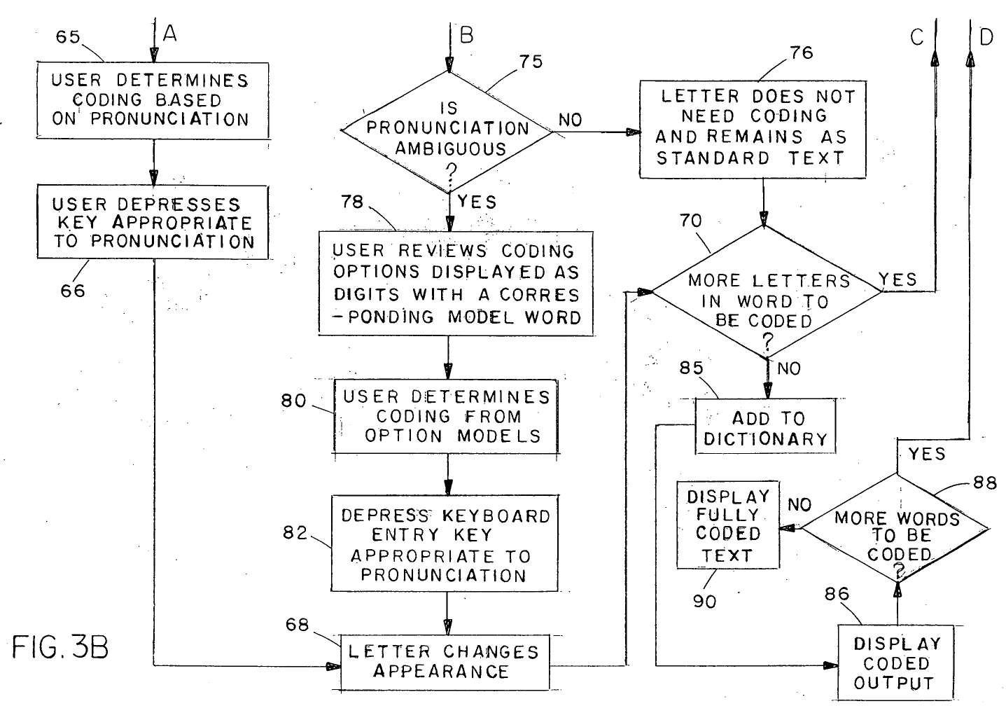

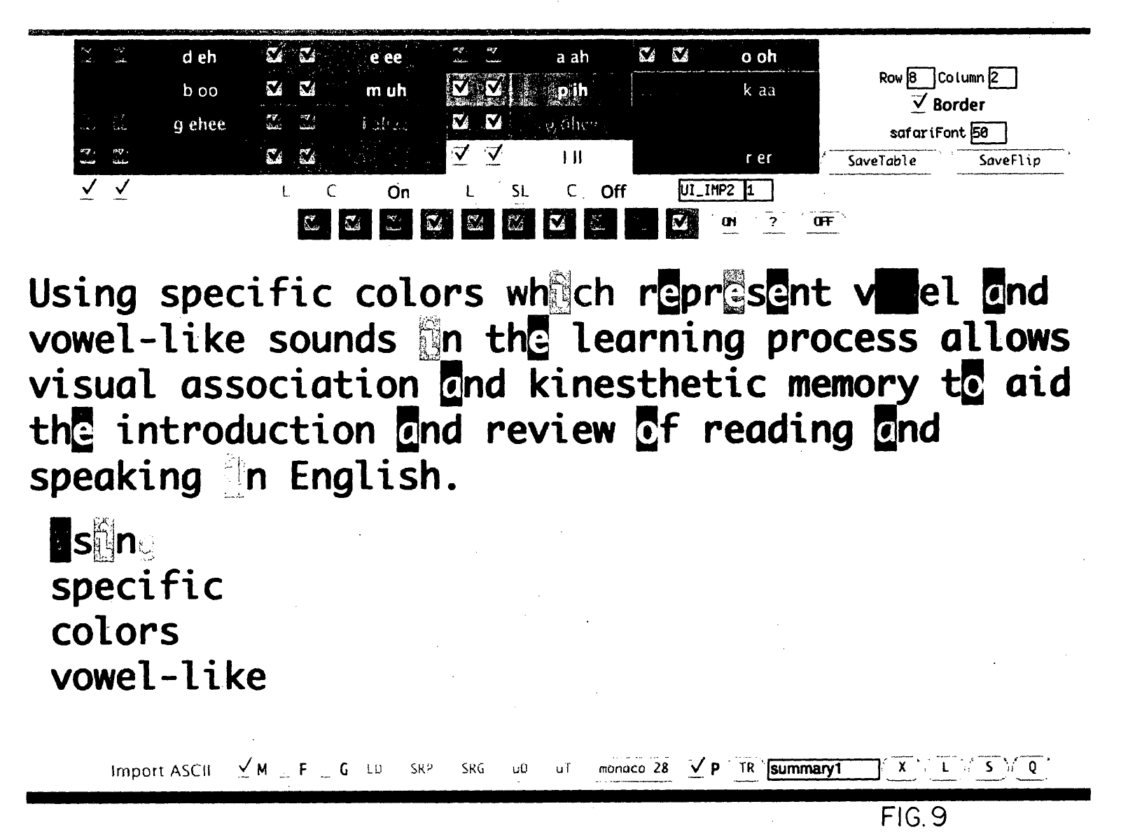

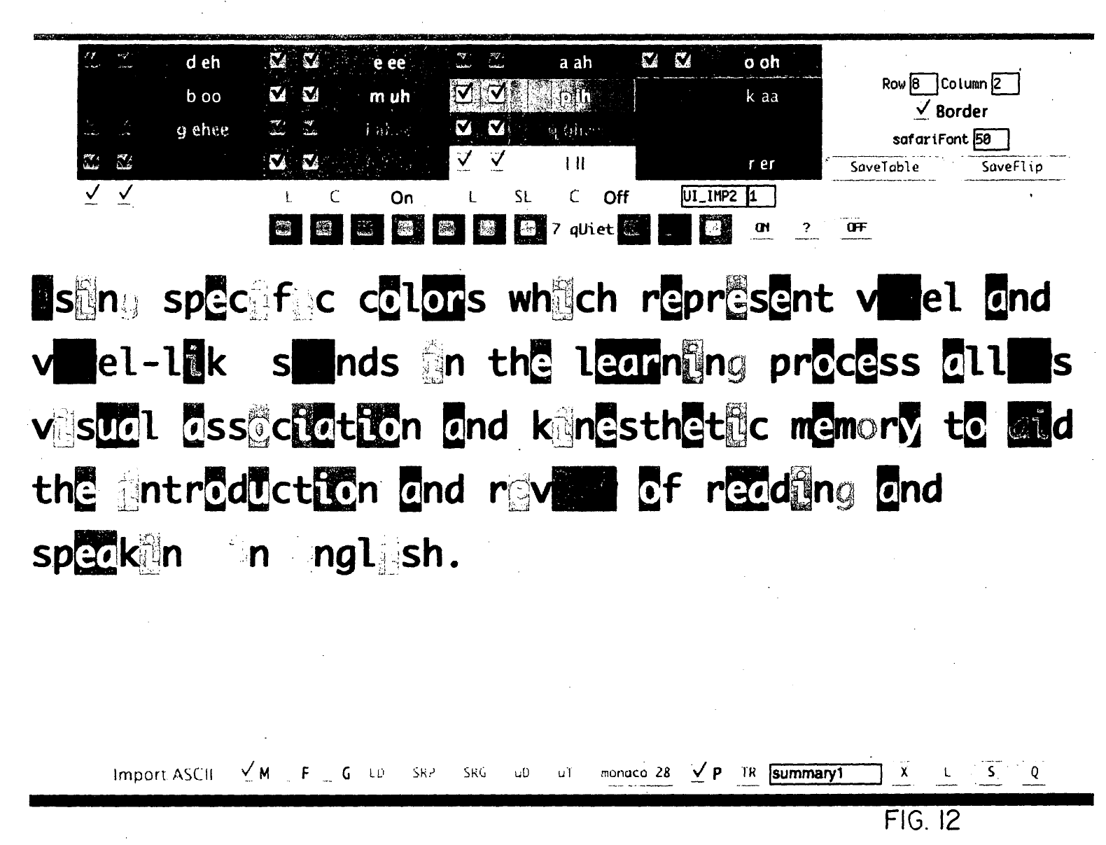

After retrieving all previously coded words from memory, the user must code each of the uncoded words. A list of the first set of uncoded words will be displayed below the text passage, as in FIG. 8. The user then selects an uncoded word for coding (generally the first uncoded word of the text, in this case the word “using”) in step 35, by placing the cursor over the first letter of the word. A word coding subroutine (36) is then carried out, which is described in more detail below in connection with FIG. 3. After the entire word has been coded, the newly coded word is entered in the database by clicking on button “uT” at the bottom of the screen (step 38), and the coded word is displayed in color (step 40). This is shown for the word “using” in FIG. 9. The user then determines whether all words are coded (step 42). If yes, the fully coded text is displayed (step 44), as in FIG. 12. If not all of the words have been coded, the user selects the next uncoded word for coding, returning to step 35, by clicking on it in the display screen and coding it letter by letter using the same subroutine as before.

The word coding or painting subroutine will now be described with reference to the more detailed flow chart of FIGS. 3A and 3B. With the system in text entry mode (45), a passage of standard black and white text can be entered, either by importing an ASCII text file (46), or by manual keyboard entry (48), and the standard text output is displayed on the screen (50). The screen display of an example of standard text before coding is illustrated in FIG. 7. The user then selects paint mode (52), by clicking on the P key at the bottom of the screen (selection of paint mode is indicated by the check in the box to the left of the P key). The uD key is then depressed (54), and the stored dictionary of previously coded words is checked automatically to determine whether any of the stored words match words in the text passage entered. If any matches are found, the screen output is changed (55) to match the dictionary appearance of each word previously entered in the dictionary. The screen display will then correspond to that of FIG. 8, in which several words in the text (“which”, “represent”, “vowel”, “and”, “in”, “the”, “to”, and so on) have been color coded to match the dictionary stored words, with the remainder of the output of uncoded words remaining as standard text (56).

The user now determines what coding needs to be applied (58), based on their knowledge of English language pronunciation and of the chromatext color coding system. Coding is accomplished by depressing a specific letter or digit associated with each tag used for color representation (see FIG. 5). Thus, the numbers 0 to 9 represent the various consonant or consonant-like color coding options, while the letters d, e, a, o, b, and so on represent the various vowel and diphthong, I, r and silent pronunciations. These letters are also displayed at the top of the screen in association with the color palette 23, as illustrated in FIGS. 7 to 14. As noted above, the chromatext program, which is written in the TCL.TK computer language, contains tags for each of the color representations. Each tag has a model name and a content. The model name is an example word written in lower case with one or more contiguous upper case letters, as a cue to the pronunciation to be indicated with the color coding for that tag. The upper case letters are cued to the specific color to be applied. The phonemes are cued when the represented phoneme is pronounced the same in both words, e.g. the tag model name, for example yEt, and the color name “red” both contain the same “eh” phoneme. In a consonant coding example, the model name for consonant code number 1, letter s, is the word “iS”, representing that pronunciation of the letter “s” in that word (and other words with the same “s” pronunciation). The content of the tag describes the specific coloring of that tag. In the case of consonant tags and silent letter tags, the content describes the foreground color representation (i.e. the color of the letter itself). In the case of vowel tags, single phoneme, the content describes the background color of the letter with a white foreground. In the case of diphthong tags, the content describes the background and foreground colors. A corresponding keyboard entry of the letter or number corresponding to a specific tag will apply the specified content to the letter or letters selected.

In order to code a word, the user first places the cursor over a letter or group of letters (such as “ch”, “sh”, “th”) to be coded (60). If the letter is a vowel or vowel-like (62), the user can refer to the color palette at the top of the screen where the color coding options are displayed in the color hue with the corresponding code character, in this case a letter (64). The user determines the proper coding based on the pronunciation of that letter in the word in question. Thus, if the user is starting the coding of the first uncoded word in the example text, “using”, they first place the cursor over the letter “u”. Based on their knowledge of American English pronunciation, they will know that this is a diphthong vowel pronunciation, “eeoo”. By reference to the palette 22, they can find the diphthong phoneme “eeoo” and determine that the code key associated with that coding is the letter “u”. They will therefore depress the letter “u” on the keyboard (66), and the letter will then change appearance (68), in this case appearing with a blue foreground and a green background. Since more letters and words are to be coded (70), the user then returns to steps 58 and 60, placing the cursor over the next letter to be coded.

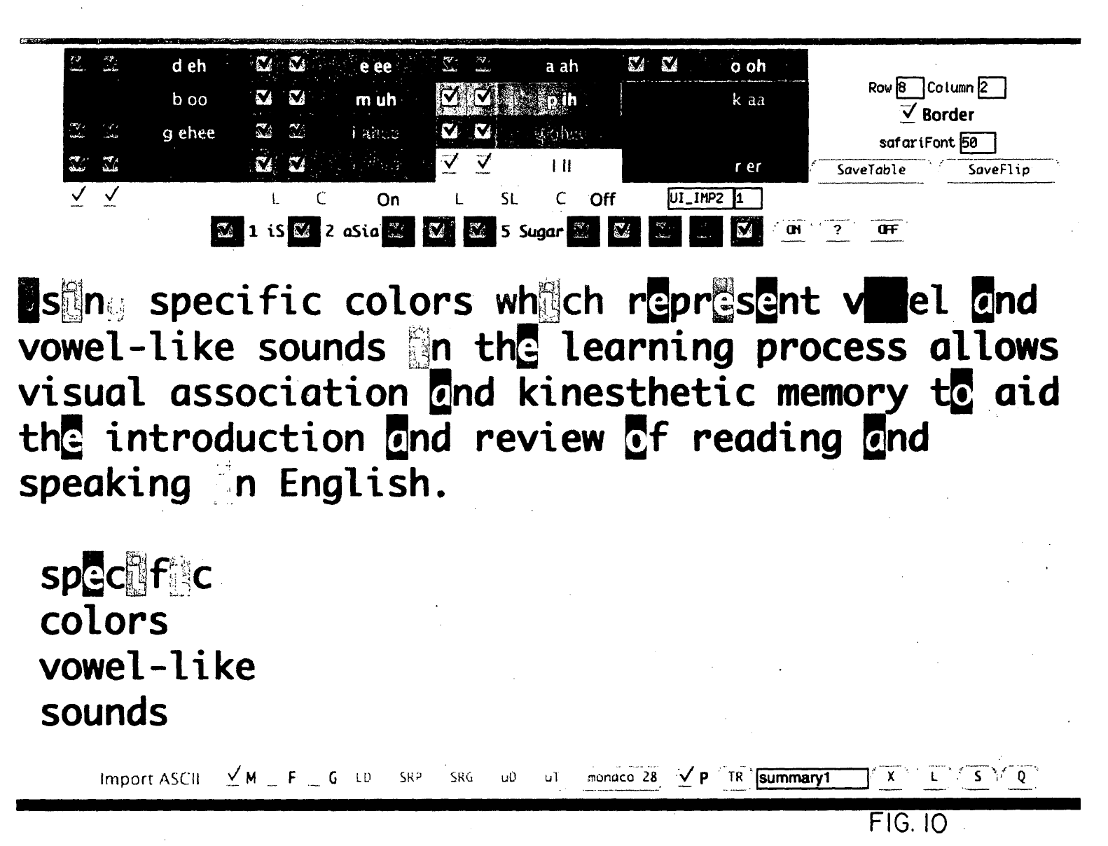

The next letter in the word “using” is the letter “s”. The user places the cursor over this letter. Since this letter is a consonant (72), a coding option model for the letter “s” will be displayed in a context sensitive menu for all possibilities (other than standard or most common pronunciation) applicable to the phoneme's pronunciation (74). This coding option model is illustrated in FIG. 10. As illustrated, when the user places the cursor over the letter “s”, the boxes in row 24 will separate so that the associated control number and model name or word for each alternative pronunciation of that letter appear to the right of the respective color box. Thus, in FIG. 10, next to the first (dark red) color box, the number “1” appears, and alongside it the model word “iS”. Next to the second box (bright red), the number “2” appears, along with the model word “aSia”. Next to the fifth box (bright blue), the number “5” appears, along with the model word “Sugar”.

The user first determines whether the particular consonant pronunciation is ambiguous, or whether the standard pronunciation is used in the word in question (75). If the pronunciation used is the standard, or if there is only one possible pronunciation, then the letter does not need coding and is left as standard black text (76). If there are several possible alternative pronunciations, the user reviews the coding options displayed at the top of the screen (78) and determines the appropriate coding for the letter in question based on these options (80). Thus, for the letter “s” in “using”, the user determines that the pronunciation is the same as the “s” in the word “iS”. The user then depresses the keyboard entry key appropriate for that pronunciation (82), which in this case is the number 1. The letter will then change in appearance (68). Since more letters remain to be coded (70), the user then places the cursor over the next letter in the word (60). In the word “using”, this will be the letter “i”, a vowel, and the steps 64 to 66 are again used to select the appropriate color coding and display the letter “i” with the appropriate color coding, in this case a pink background, with the user depressing keyboard letter key p to apply the coding background color. The next letter, “n”, is a consonant and placing the cursor over this letter will produce color coding options for this letter in the row 24 (1 siNg and 2 blaNc, in this case). The user can determine that the pronunciation of “n” in “usiNg” is the same as in the code word “siNg”, and will therefore depress key 1 on the keyboard to apply the appropriate color.

The final letter in the word “using”, the letter “g”, is a silent letter in this context. Silent letters are indicated in the color palette 22 by a letter “x” and the word “silent”, both colored gray. Thus, if the selected letter is “silent” (84), the user will again determine the appropriate coding from palette 22, as in the case of vowels (step 65), and will depress keyboard key “x” in order to color the silent letter gray.

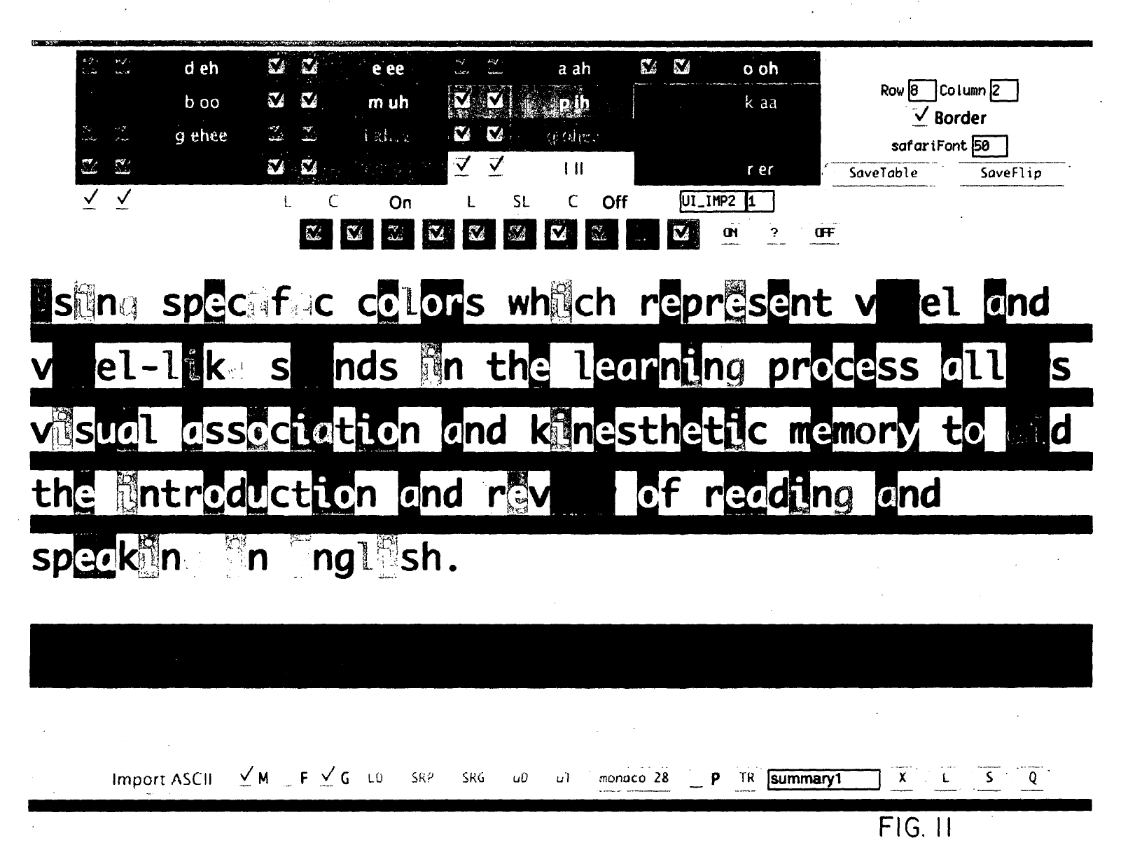

When there are no more letters in a particular word to be coded, the user depresses the key uT in order to add that word to the dictionary (85), and the coded output to date will be displayed (86), as indicated in FIG. 10. Since more words remain in the text to be coded (88), the user will now move on to the next word in the text (in this case the word “specific”), placing the cursor over the first letter in that word (step 60), and repeating the same procedure until the entire word is coded. The procedure is repeated until every uncoded word in the text has been coded and entered in the dictionary, at which point the fully coded text is displayed (step 90). The fully coded text for the example passage is illustrated in FIG. 11.

Any color coding can be edited if necessary after the initial coding steps. For example, the coding applied by reference to the dictionary to the second word “the” in the text does not provide the proper pronunciation. In order to remove coding and apply new coding, the cursor is simply placed over the letter to be changed, and a new keyboard entry is made based on the desired coding. In the initial dictionary applied coding of FIG. 8, the letter “e” in the second “the” has a mud-colored background, indicating a vowel pronunciation “uh”. However, the word “the” in the phrase “the introduction” has an “e” which is pronounced “ee”, not “uh”. The user therefore depresses the keyboard key “e”, and the color of the letter “e” background is changed to green, as illustrated in FIGS. 9 and 10. The software may be modified so that the coloring of the “e” background in “the” is automatically switched between mud and green, depending on whether it is followed by a word starting with a consonant or a word starting with a vowel. However, this may also be done manually by the user when editing the applied color based on their knowledge of English pronunciation.

There are other words which have alternative pronunciations based on usage. Such words may be associated with a pop up window to which the user may refer when they are selected, in order to select the proper coding based on usage. Although the word “the” is automatically coded one way only from the dictionary in the illustrated embodiment, in practice words such as “the”, “project”, “read”, and so on, which have alternative pronunciations based on usage, will be stored in the dictionary with an extension and must be selected manually. For example, the word “the” before a vowel is entered in dictionary as “the(bv)” and the word “the” before a consonant is entered as “the(bc)”. Other extensions would include (n) for noun, (v) for verb, (pres) for present tense and (past) for past tense. The software will therefore include a look up table of such words and will allow new words with extensions be entered into the dictionary after coding. The file display output as .html or .pdf will not show the extension.

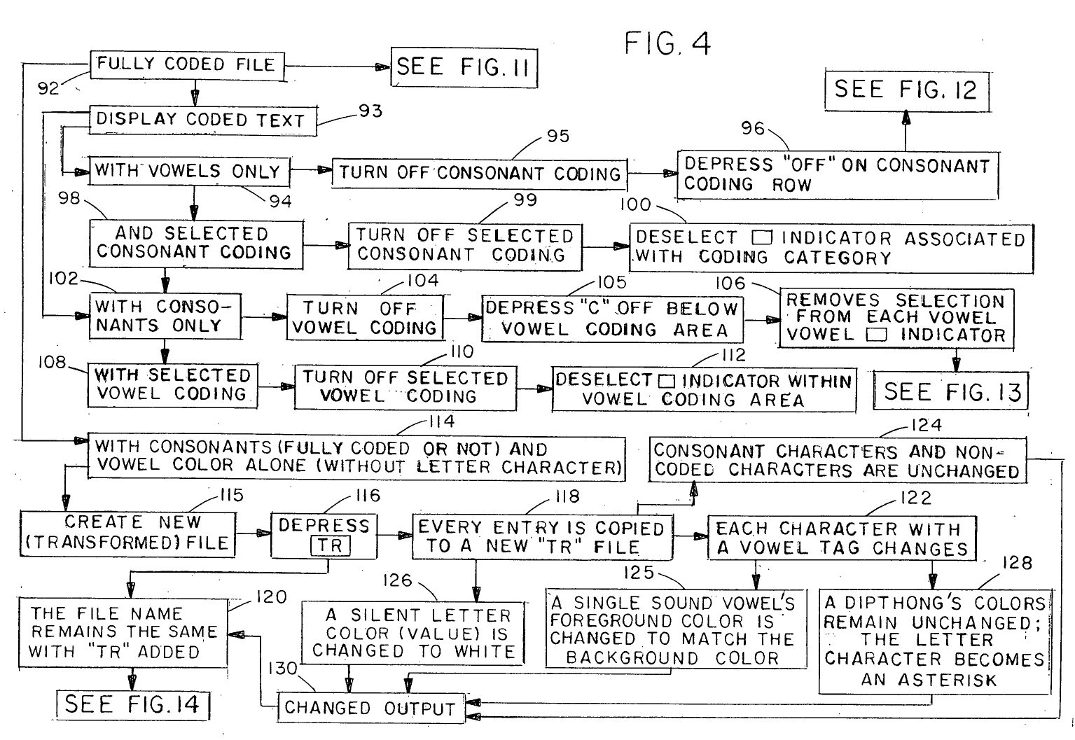

If the user wishes to remove all of the applied coding and return to black and white text, they simply depress the escape key on the keyboard. Other display options are possible, as indicated in the flow diagram of FIG. 4. In order to change the appearance of the fully coded file (92) of FIG. 11, various options are possible. If the user wishes to display the coded text with vowels only (94), the consonant coding can be turned off (95) to display only the vowel and vowel-like pronunciation coding. In this case, the “OFF” key to the right of the consonant coding row 24 has been depressed (96), and all of the consonant coding boxes are unchecked. This removes all consonant coding from the text, so that consonants are all shown in black (apart from any silent consonant letters), as indicated in FIG. 12. If the user wishes to turn off only some of the consonant coding (98), they simply turn off selected consonant coding (99) by clicking on selected consonant coding category boxes (100) to uncheck them.

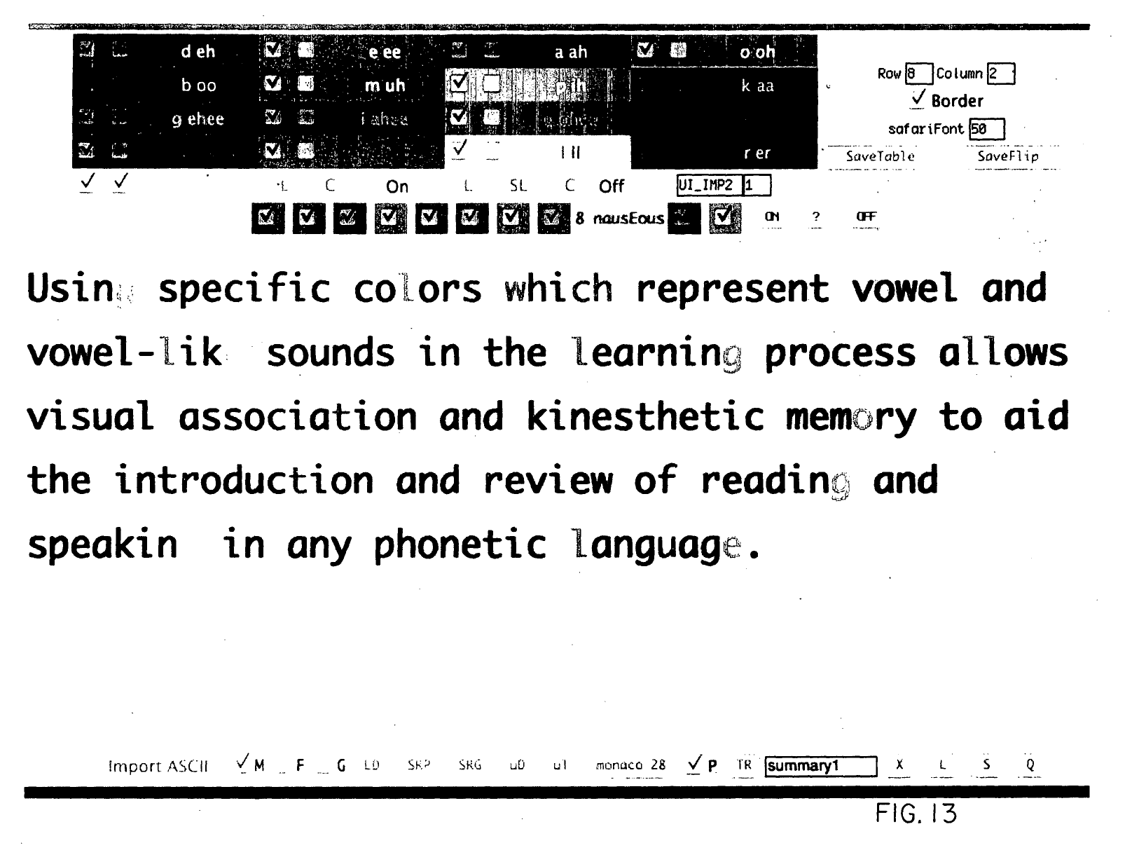

The text can also be displayed with consonant coding only (102). This alternative is illustrated in FIG. 13. In this case, the user turns off all of the vowel coding (104) by unchecking all of the vowel color coding boxes. This is done by selecting “C” and “OFF” keys below the color palette (105). This removes the selection from each vowel color indicator box (106), and results in the display as in FIG. 13. The user can also opt to remove only selected vowel coding, rather than all vowel coding (108). This is done by turning off only the color coding for one or more selected vowels (110), when the user deselects the color box associated with the particular vowel coding area (112).

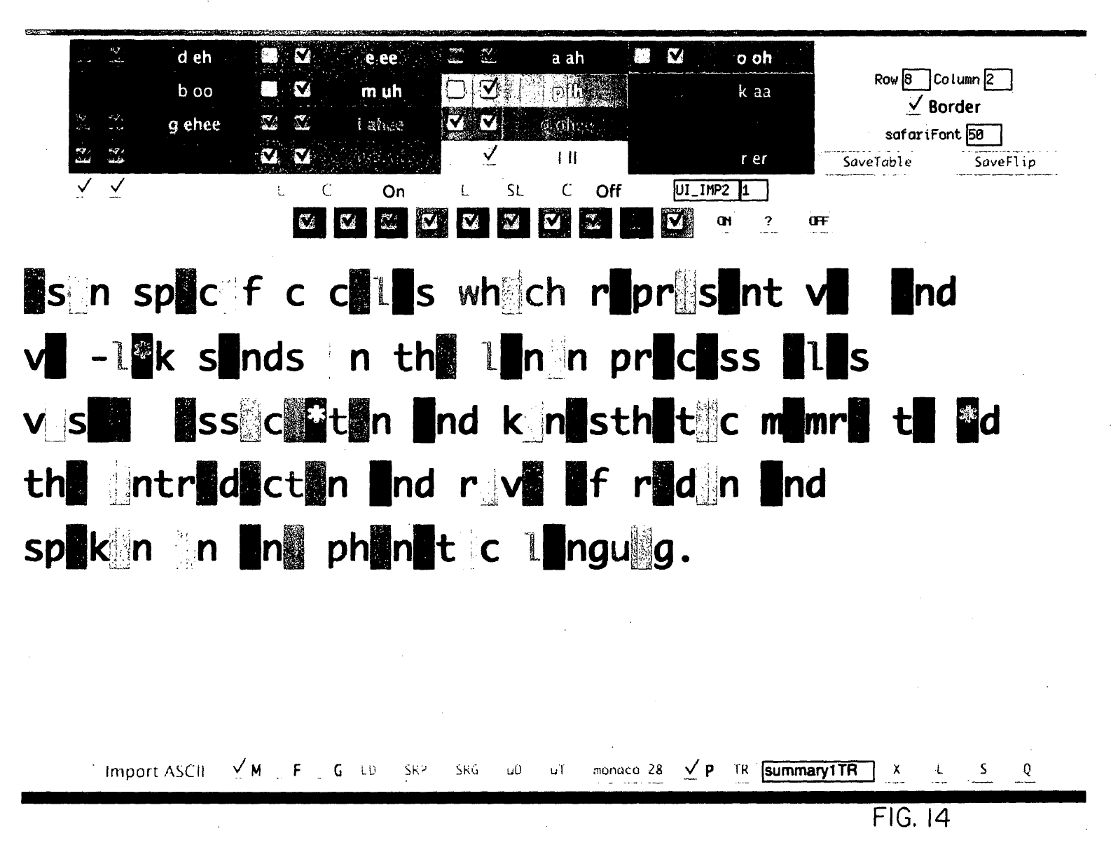

Another display option is with consonants fully coded and showing the vowel color alone (114), without the associated letter. One example of this is illustrated in FIG. 14, where the L or letter boxes of certain vowels have been turned off (unchecked or deselected). In this case, all of the L boxes for vowels are turned off, apart from the diphthongs. A transformed file is created (115) by depressing the TR key at the bottom of the screen (116). Every entry is copied to a new, transformed file (118), and the file name will remain the same with a “TR” added at the end (120), as can be seen in the file name box at the bottom of th screen in FIG. 14. Each character in the text which has a vowel tag in the program will change in appearance (122), while consonant characters and non-coded characters remain unchanged (124). All single sound vowel vowels are changed to change the foreground color to match the background color, so that a single color box appears in place of the vowel (125). Thus, all “ih” sound vowels are changed to pink boxes, all “eh” vowels are changed to red boxes, and so on, as can be seen from a comparison of FIGS. 11 and 14.

At the same time, all silent letter colors or values are changed to white (126), so that these letters simply disappear from the text. A diphthong's colors remain unchanged, but the letter character changes to an asterisk (128). Thus, referring to the diphthong “eeoo” for the letter “u” at the start of the word “using” in the example text, the letter “u” is changed to a blue asterisk on a green background in FIG. 14. Once all vowels, diphthongs, and silent letters have been transformed, the fully changed or transformed output (130) is displayed. This output will allow teaching of proper pronunciation of vowels and vowel-like sounds without reference to the particular letter or letters involved.

The coded displays can be printed or projected for use in a classroom or with individual students, or may be transmitted to networked computers for student use. The program may also store previously coded texts for use in addition to independently created documents.

The computer system and program described above in connection with FIGS. 1 to 14 allows any selection of text to be color coded with specific colors to represent vowel and other voiced and non-voiced sounds. The color coded text can be printed out in any desired format for use as a teaching tool, or may be used by students on the computer itself as an aid to learning proper American English pronunciation. In order to use this teaching tool, the student will first learn the color names, and then the associated target sound in the color name, e.g. the proper pronunciation of the word “red”, and then the target vowel sound “eh”. Once these basic concepts have been taught, the student can use the colors and their associated sounds to reinforce basic pronunciation, introduce new vocabulary, and clarify difficult pronunciations. This system can also be used to supplement the process of spelling specific words, build an understanding of the varied (and often conflicting) spellings found in American English, and to demonstrate the effect of stress in multi-syllable words. Finally, the system can be used to read any color coded text. It will be understood that the same basic color coding system may be used for teaching pronunciation in any language, simply by varying the color selection based on vowel and other sounds in that language, using the same principles as described above. It may also be used to teach British English pronunciation rather than American English.

The reading and pronunciation teaching system of this invention can be used to teach reading as well as pronunciation both to native speakers of a language and second language learners. The colors used are distinctive and easily remembered cues to pronunciation and word recognition. The vowel (single and diphthong) colors are selected and identified according to their name as spoken in the language under study (thus, the same colors as described above will not be appropriate in other languages with different words for colors and vowel pronunciations). The colors are chosen for containing the same spoken sound (phoneme) as each of the voiced phonemes used in that language. In this system, additional colors are also used to differentiate and categorize consonants and all other non vowel-like phonemes and consonant clusters whose pronunciation can be interpreted in more than one way. Once the student has learned these colors and the associated pronunciation, they will be able to pronounce new words which have been properly color coded with little effort.

This system will make the process of learning to read and pronounce words in any language easier and faster. Recognition of the color and color name is used to aurally, visually, and kinesthetically correlate sounds to words in print and speech. The system and method for creating the color coded text will be a useful aid to teachers, since it will enable them to quickly and easily created a color coded version of any text they wish to teach. The data base may also include some previously coded and stored texts for teachers to use if they do not want to create new coded text.

The system and method of this invention enable standard text to be printed in a text with color coding that fully represents contemporary pronunciation. The color coding can be applied to any selected text using the rules of phonetics and the unique color coding of this invention. The color coding method described above applies a direct relationship of recognition and pronunciation of a phoneme in a color name to the voiced phonemes used in a text. This system enables pronunciation focus to be centered on the core of the sound. Known phonetics methods require the reader to apply rules, context, and many exceptions as a means of decoding text. With this system, the large number of rules to pronunciation based on context and exceptions do not have to be memorized initially. Instead, the beginning reader or language learner simply has to learn the various sounds associated with the coding colors, which is much easier than learning all the pronunciation rules, including exceptions, for an entire language in advance.

Although an exemplary embodiment of the invention has been described above by way of example only, it will be understood by those skilled in the field that modifications may be made to the disclosed embodiment without departing from the scope of the invention, which is defined by the appended claims.

1. A method for teaching pronunciation and reading, comprising the steps of:
utilizing a color coded text passage in which all letters in the text associated with single phoneme vowels and vowel-like sounds are represented in predetermined colors whose color name contains the same phoneme as the vowel or vowel-like sound that it represents, and all letters associated with vowel diphthongs having two vowel sounds are represented by both background color and letter character color, each color having a color name containing the same phoneme as the vowel sound it represents, all consonants having non-standard pronunciations are represented in predetermined colors, and all consonants having standard pronunciation are not color coded; and
teaching the pronunciation of words in said text using the color coding to indicate proper pronunciation.

2. The method as claimed in claim 1, wherein all silent letters in the text are colored in a predetermined color different from all other colors used to code the text.

3. The method as claimed in claim 1, wherein all silent letters in the text are converted to blank spaces.

4. The method as claimed in claim 1, wherein the color coding of all letters associated with single phoneme vowels and vowel-like sounds comprises a background color for the associated letter.

5. The method as claimed in claim 4, wherein all letters associated with single phoneme vowels and vowel-like sounds are removed from the text, leaving only the background color displayed to indicate the vowel sound.

6. A system for producing color coded text for use in teaching proper pronunciation, comprising:
a computer;
display means associated with the computer;
the computer having input means for receiving selected text passages and displaying the uncoded passage on the screen to a user;
storage means in the computer containing a dictionary of at least some commonly used words having only one pronunciation in which each word is color coded to represent the proper pronunciation of that word;
a program associated with the computer for searching uncoded text and associating any words in the text which are stored in the dictionary with the corresponding color coded word and displaying the color coded words in the text on the display means; and
the program further comprising means for displaying a color coding menu on the display means for reference by the user in applying color to words in the selected text passage, user control means for color coding of letters in words which are not already stored in the dictionary, the control means comprising means for associating a selected letter or group of letters in the text with a color coding in the menu corresponding to the proper pronunciation of the selected letter or group in the word in which they are located, means for applying color to the selected letter or group of letters in the displayed text according to the associated color coding, and means for displaying the text passage with all words color coded after all words have been either associated with words already stored in the dictionary in color coded form or color coded by the user.

7. The system as claimed in claim 6, wherein the color coding menu includes a series of double letters representing single phoneme vowel sounds and an associated colored area for each double letter, the word for the color in each color box containing the same spoken sound as the voiced vowel phoneme it represents.

8. The system as claimed in claim 7, wherein the single phoneme vowel sounds are represented by the double letters “eh”, “ee”, “ah”, “oh”, “oo”, “uh”, “ih”, and “aa” and the associated colored areas are colored red, green, auburn, orange, blue, mud, pink, and black, respectively.

9. The system as claimed in claim 7, wherein a control key for application of the color coding is provided adjacent each double letter in the menu.

10. The system as claimed in claim 9, including a keyboard for user entry of data and control characters for controlling the software, the control keys on the color coding menu comprising characters for entry by a user on the keyboard to produce the corresponding color in association with a selected letter or group of letters in the displayed text.

11. The system as claimed in claim 9, wherein operation of a control key comprises means for applying the selected color as a background color to a selected letter or group of letters in the text.

12. The system as claimed in claim 7, wherein the color coding menu further comprises a series of letter groups representing diphthong vowel sounds and the associated color coding for each diphthong.

13. The system as claimed in claim 12, wherein each diphthong letter group in the color coding menu has a background color representing one phoneme of the diphthong and a letter color representing the other phoneme of the diphthong.

14. The system as claimed in claim 13, wherein a unique keyboard control character is provided in the menu adjacent each diphthong letter group for entry by a user in order to apply the associated color coding to a selected letter or group of letters in the text.

15. The system as claimed in claim 6, wherein the color coding menu includes a series of colored boxes representing color coding for application to consonants in the text in words where the consonant pronunciation is non-standard.

16. The system as claimed in claim 15, including means for displaying alternative color coding option models for consonant pronunciation on the screen in response to user selection of a consonant having a non-standard pronunciation, whereby the user can select the appropriate coding from the coding option model.

17. The system as claimed in claim 6, wherein the program includes means for entering words which have been color-coded by a user into the dictionary.

18. The system as claimed in claim 6, wherein the program includes means for applying unique color coding to single and double phoneme vowels, consonants having at least one non-standard pronunciation, and silent letters in words based on the word pronunciation.

19. The system as claimed in claim 18, further comprising means for providing a series of alternative color coded displays, including a first display in which each vowel or vowel-like sound, non-standard consonant sound, and silent letter in the text is color coded, and at least one additional display in which the letters representing single phoneme vowels are removed to leave only a background color box representing the vowel sound.

20. The system as claimed in claim 19, in which silent letters are removed from the text to leave blank spaces in said additional display.

21. The system as claimed in claim 19, further comprising means for providing a second additional display in which the vowel color coding is removed to display only consonant color coding, and a third additional display in which the consonant color coding is removed to display only vowel color coding.

22. The system as claimed in claim 21, including user input means for controlling the display on the screen.

23. A method for converting a passage of text into the corresponding text which is color coded to provide a teaching tool, the method comprising the steps of:
providing a dictionary of some common words converted into corresponding color coded words in the data base of a computer;
providing a color coding menu on a computer display screen for providing information to a user on the proper color coding to be used for letters based on pronunciation;
entering a conventional text passage into the computer;
displaying the passage on the computer display screen adjacent the color coding menu;
searching the dictionary for any color coded words corresponding to words in the entered text;
converting all words found in the passage which are in the dictionary into the corresponding color coded word;
displaying the color coded words in the passage on the screen along with the non-coded words not found in the dictionary;
for each non-coded word, selecting an appropriate color coding from the menu for each letter or group of letters in the word apart from consonants having only one possible pronunciation, based on pronunciation of that letter or group of letters in the respective non-coded word, and applying the selected color coding to the selected letters or groups of letters in the word; and
after each word has been color-coded, displaying the color-coded passage on the screen.

24. The method as claimed in claim 23, including the step of adding newly color-coded words to the dictionary.

25. The method as claimed in claim 24, including means for adding words having the same spelling but more than one possible pronunciation to the dictionary.

26. The method as claimed in claim 23, wherein the color coding menu comprises a series of vowel and vowel-like sounds and associated colors, and a series of coding colors for coding of consonants having more than one possible pronunciation depending on the word in which they occur.

27. The method as claimed in claim 26, wherein at least single phoneme vowels and vowel-like sounds are associated with colors whose color name contains the same phoneme as the vowel or vowel-like sound that it represents.

28. The method as claimed in claim 27, wherein all vowels and vowel-like sounds are associated with colors whose color name contains the same sound as the vowel or vowel-like sound it represents.

29. The method as claimed in claim 27, wherein double phoneme vowels and vowel-like sounds are represented by a first color in the background of a letter and a second color in the letter itself.

30. The method as claimed in claim 23, wherein the color coding menu includes an unique color for representing silent letters in words.

31. The method as claimed in claim 23, including the step of displaying in the color coded text all consonant letters which have only one possible pronunciation in the standard color assigned to the original, uncoded text.

32. The method as claimed in claim 23, wherein the step of converting uncoded words in the text into color coded text comprises selecting letters corresponding to vowels or vowel-like sounds in words and applying a colored background to each selected letter or group of letters based on the sound produced by the letter or letters when the word is pronounced.

33. The method as claimed in claim 32, further comprising applying a second color to each selected letter or letters having a diphthong sound, in addition to the colored background, the second color being applied to the letter itself, the color of the background representing one vowel sound of the diphthong and the second color being different from the background color and representing the other vowel sound of the diphthong.

34. The method as claimed in claim 32, further comprising selecting consonants having non-standard pronunciations in the text and applying a selected color to each selected consonant based on its pronunciation in the word in which it occurs.

35. The method as claimed in claim 34, further comprising the step of displaying non-standard pronunciation coding options to a user on selection of a consonant in the text to enable the user to select the appropriate color coding for the selected consonant based on the pronunciation in the word in which it occurs.

36. A teaching tool for teaching pronunciation, comprising:
a display medium;
a selected text passage displayed on the display medium;
the text passage having a first unique color coding applied to all vowel letters and letters having vowel-like pronunciation, and a second unique color coding applied to all consonants having non-standard pronunciations;
the color-coding applied to letters having vowel or vowel-like sounds comprising predetermined colors in which the word for each color contains the same vowel sound as the vowel or vowel-like sound it represents; and
one of said color codings comprising a background color for a letter of a different color and the other of said color codings comprising a color applied to a letter itself.
